(19) United States
(12) Patent Application Publication
(10) Pub. No.: US 2005/0146497 A1
(43) Pub. Date: Jul. 7, 2005

(54) Peripheral device including features of a mouse and of a remote control unit

(76) Inventor: Edward O. Clapper, Tempe, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/749,304

(22) Filed: Dec. 31, 2003

(51) Int. Cl. G09G 5/00

(52) U.S. Cl. 345/156

(57) ABSTRACT

In some embodiments an apparatus includes mouse features and remote control unit features. The mouse features include surface based navigation such that a movement of the apparatus relative to another object is translated into electronic signals. Other embodiments are described and claimed.

### TECHNICAL FIELD

The inventions generally relate to a peripheral device including features of a mouse and features of a remote control unit.

### BACKGROUND

Convergence devices have become available that combine features of computers (for example, PCs) and consumer electronic (CE) devices (for example, TVs). However, these convergence devices have previously used a remote control device that is a separate device from the mouse device. This can become a hassle for a user to switch between remote control and mouse devices while using the convergence device.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 is a top view illustrating a peripheral device according to some embodiments of the inventions.

FIG. 2 is a right side view illustrating a peripheral device according to some embodiments of the inventions.

FIG. 3 is a left side view illustrating a peripheral device according to some embodiments of the inventions.

FIG. 4 is a view illustrating a peripheral device according to some embodiments of the inventions.

### DETAILED DESCRIPTION

Some embodiments of the inventions relate to a peripheral device combining features of a mouse and a remote control unit.

In some embodiments an apparatus includes mouse features and remote control unit features. The mouse features include surface based navigation such that a movement of the apparatus relative to another object is translated into electronic signals.

In some embodiments a system includes a screen, media processed from a source, and a peripheral to interact with the processed media for display on the screen. The peripheral includes mouse features and remote control unit features. The mouse features include surface based navigation such that a movement of the peripheral relative to another object is translated into electronic signals.

In some embodiments a single device is used to switch between media control and computer control. The device includes mouse functions and remote control functions. The mouse functions include surface based navigation such that a movement of the device relative to another object is translated into electronic signals.

In some embodiments media control and computer control are performed using a single device that includes mouse functions and remote control functions. The mouse functions include surface based navigation such that a movement relative to another object is translated into electronic signals.

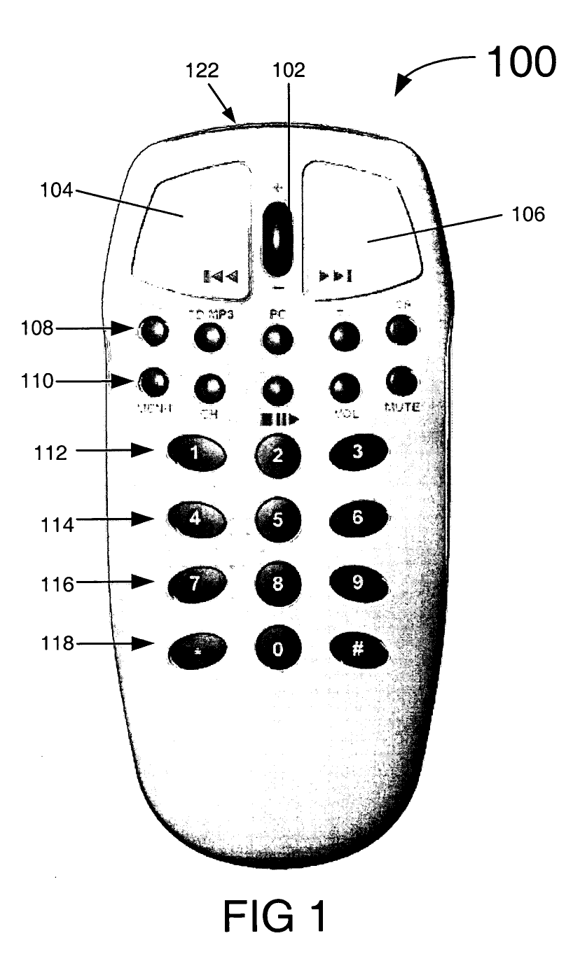

FIG. 1 illustrates a peripheral device 100 according to some embodiments. Peripheral device 100 includes a scroll wheel 102, a button 104 (left click), a button 106 (right click) 106, a first row of buttons 108 (including, for example, DVD, CD and/or MP3, PC (or more generally “computer”), TV and VCR mode buttons), a second row of buttons 110 (including, for example, menu, channel, stop/pause/play, volume and mute buttons), a third row of buttons 112 (including, for example, number 1, 2 and 3 buttons), a fourth row of buttons 114 (including, for example, number 4, 5 and 6 buttons), a fifth row of buttons 116 (including, for example, number 7, 8 and 9 buttons), a sixth row of buttons (including, for example, asterisk *, number 0, and pound sign # buttons), and a communication port 122 (for example, a short-range radio frequency RF and/or infrared port). Peripheral device 100 also includes on the bottom side (not illustrated) additional mouse features (for example, peripheral device 100 can function as an optical mouse without moving parts via optical transception on the bottom of the device). The scroll wheel 102, button 104 (left click) and button 106 (right click), and the additional mouse features on the bottom of peripheral device 100 as described above are mouse features that may be included in peripheral device 100 according to some embodiments. In some embodiments these mouse features 102, 104, 106 (and of the bottom of the device) can perform functions similar to that of a mouse, as well as additional functions. The first, second, third, fourth, fifth and sixth row of buttons 108, 110, 112, 114, 116 and 118 are similar to buttons currently found on some consumer electronics (CE) devices (for example, audio/visual devices), although all of these buttons may not be found on CE devices (for example, a “PC” button as in the first row 108).

As mentioned above, peripheral device 100 also includes on the bottom side (not illustrated) additional mouse features. Specifically, the bottom of the device 100 includes surface navigation by moving the device 100 relative to a surface (for example, in some embodiments a flat table surface, a pant leg, a cushion of a sofa, a floor surface, etc.). The surface navigation is surface based transception that translates movement of the bottom of device 100 relative to another surface into electronic signals. Such surface navigation is implemented in some embodiments with features of an electronic mouse using a ball cage at the bottom of the mouse that rolls relative to a surface. In some embodiments, device 100 functions as an optical mouse without moving parts via optical transception on the bottom of the device. Such ability to function as an optical mouse would allow the mouse bottom to navigate relative to many surfaces without requiring moving parts and/or the mouse to actually touch the surface (since optics are used rather than physical moving parts).

In some embodiments the surface navigation is used as a way to control something. The physical surface navigation may be used as a media transport. For example, a normal DVD player (with typical remote control buttons) allows a DVD to be played, a pause, fast forward, etc. to occur. Some DVD and/or VCR players have a jog wheel which allows a user to perform fast forward. According to some embodiments a user could fast forward a DVD, VCR tape, etc. using surface navigation similar to a “scrubbing tool”. That is, the mouse may be moved in a predetermined direction (for example, right for fast forward, left for rewind). The faster the mouse is moved the faster the media would be fast forwarded (or rewound), for example. In some embodiments the moving of mouse could be implemented in conjunction with some other button (for example, in some embodiments moving the mouse fast in a particular direction along with hitting the right click button).

In some embodiments a switching of the device may be performed (for example, between media control and computer control) based on the context of the device (or the “focus” of the device). For example, in a computer software environment even though three software applications might be running at once, only one of those three applications can have the “focus”. In some embodiments the device 100 might need to know whether to control a TV or a computer, for example. This can be determined based on the context. The context may be identified, for example, based on a user input (for example, a button on the device, user input through software indicating different scenarios where the user pre-selects a particular context, all functions mapped out in advance, etc.) and/or may be based on computer determination. The context is automatically detected and/or understood. For example, if a user switches from a computer mode to a DVD mode, then all transport functions switch over to the context of a DVD player. In some embodiments a user might pre-select that whenever the user's favorite TV shows are playing (or about to play in five minutes, for example) then change the context to a TV context so that the device will navigate the TV function.

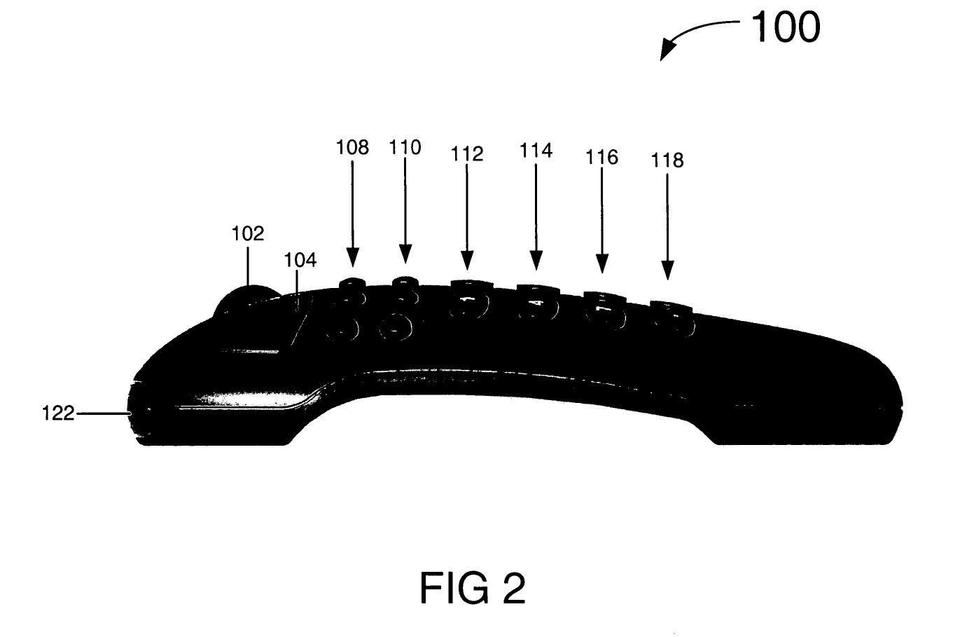

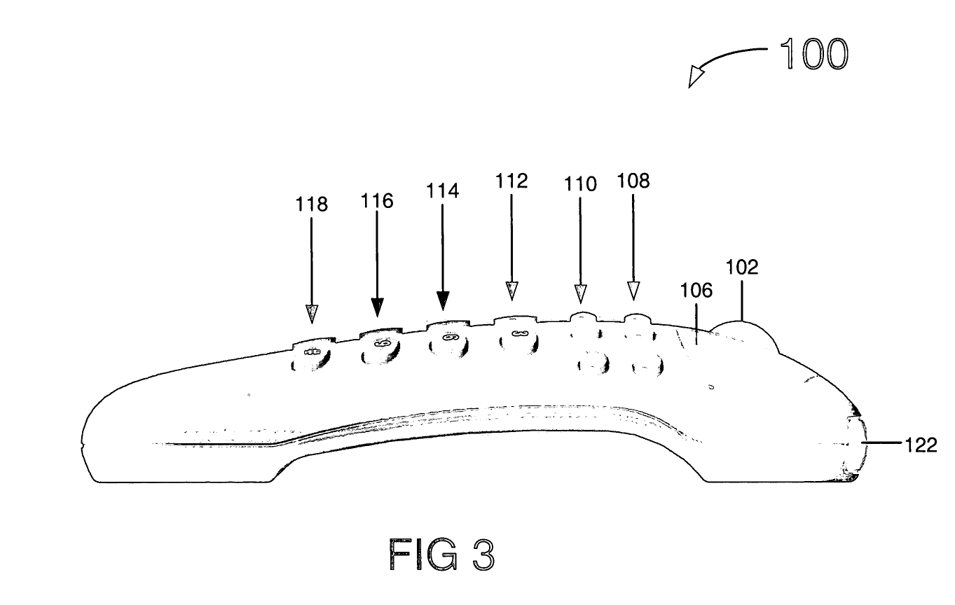

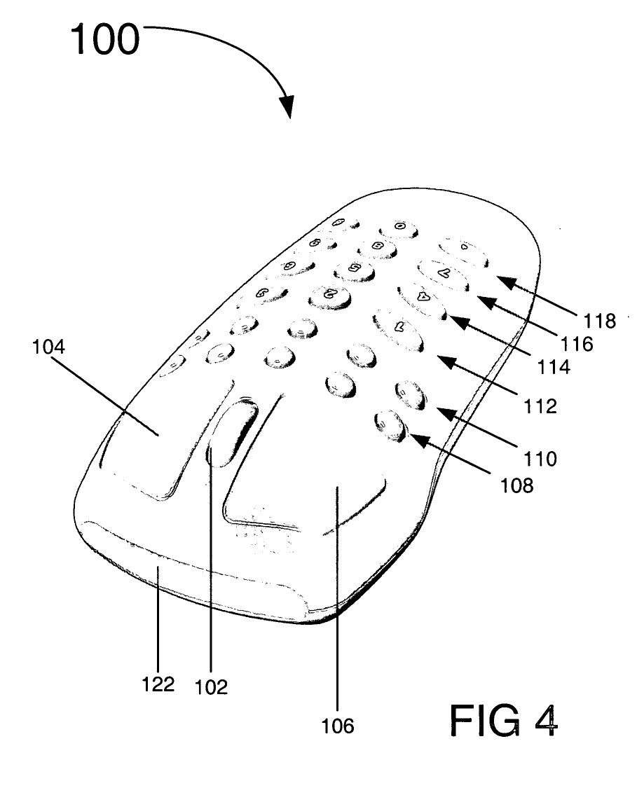

FIG. 2 illustrates a left side view of peripheral device 100 according to some embodiments. FIG. 3 illustrates a right side view of peripheral device 100 according to some embodiments. FIG. 4 illustrates another view of peripheral device 100 according to some embodiments.

In some embodiments a peripheral includes the capabilities, functions, and/or features of a mouse and of a consumer electronics (CE) remote control unit. In some embodiments a handheld convergence peripheral includes the capabilities, functions, and/or features of a mouse and of a consumer electronics (CE) handheld remote control unit. In some embodiments the peripheral communicates with a computer and/or with a consumer electronics (CE) device using mouse and/or CE capabilities, features and/or functions.

In some embodiments a peripheral device can be set to control and/or interact with some or all of the following devices: a VCR, a TV, a computer (and/or a PC), a set top pointing device, a set top box, a set top device, a set top computer (for example, a set top PC), a CD (compact disc) device (for example, CD player and/or recorder), a DVD device (for example, DVD player and/or recorder), an MP3 device (for example, MP3 player and/or recorder), a personal video player, a personal video recorder (PVR, such as a TiVo device that can record and play video), a convergence device (for example, a converged computer/consumer electronics device such as a Gateway Media Center PC), etc. Control of these various devices can be implemented in some embodiments by using common control buttons such as a scroll wheel, number entry, etc. In some embodiments a mode button is chosen to control the device that a user is interested in controlling or using. In some embodiments some of the devices (for example, DVD player) could be a “virtual device”. That is, the DVD player (or other device) could be a virtualized DVD player (or other device) running on software of a computer.

In a mouse mode, a peripheral device according to some embodiments functions as a mouse to move the device relative to a surface (for example an optical mouse without any moving parts using optical transception on the bottom of the device). In some embodiments the peripheral device is in communication with a computer and/or CE device via short-range RF (radio frequency) and/or is in communication with legacy CE devices using infrared. In some embodiments a scroll wheel on a peripheral device may be used to do any or all of the following: volume adjustment, channel navigation, scroll bar navigation, zoom function, and fast forward/rewind in video and/or audio player control (for example, in a shuttle mode).

In some embodiments the peripheral device allows a user to switch between media control and computer use without changing the device. In some embodiments the user is able to more quickly understand the full features of a device, since the functions are evident in the remote interface itself. In some embodiments, using a combination of RF and infrared, the device can be made to be a universal remote that, in some embodiments is configurable by a computer. In some embodiments a mode button may be used in conjunction with the number pad (for example, to select multiple computers, TVs, etc.) In some embodiments the number pad on the peripheral device may be used to enter numbers in the same way as the numeric keypad of a keyboard.

In some embodiments the scroll wheel may be used to provide functional control in a wide variety of different contexts. For example, in any device mode, the scroll wheel may be used to adjust different features (for example, a device is chosen with a device mode button, the volume button (VOL) is then depressed and the scroll wheel is then used to activate volume control by moving the scroll up or down to adjust volume up or down accordingly). Additionally, for example, in a TV device mode, the channel function may be activated by hitting a CH (channel) button, and the scroll wheel may then be used to change TV channels. Similar functions may be implemented, for example, for DVD chapters, CD song selections, fast forward, rewind, etc. by using the scroll wheel and/or the left and right click buttons.

In some embodiments a rigid button structure may be used to ensure that a user does not inadvertently push some of the other buttons when the user is using the mouse functions of the peripheral. In some embodiments software may be used to provide the peripheral device with some conceptual logic to determine whether or not a button pushed in a certain mode (or context) was really intended or not.

Although some embodiments have been described in reference to particular implementations such as a peripheral device having the particular features, functions, buttons, etc. illustrated in the drawings, other implementations are possible according to some embodiments (e.g., a peripheral device with different features and functions than those illustrated in the drawings and described herein). Additionally, the arrangement of remote control features and mouse features illustrated in the drawings and described in reference thereto need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state, or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

1. An apparatus comprising:
mouse features that include surface based navigation such that a movement of the apparatus relative to another object is translated into electronic signals; and
remote control unit features.

2. The apparatus according to claim 1, wherein the mouse features additionally include a scroll wheel and at least one mouse click button.

3. The apparatus according to claim 1, wherein the surface based navigation of the mouse features includes an optical mouse transception device on the bottom of the apparatus.

4. The apparatus according to claim 1, wherein the remote control unit features are features including number buttons and at least one mode selection button.

5. The apparatus according to claim 1, wherein the at least one mode selection button is to be used to select at least one device to be controlled by the apparatus.

6. The apparatus according to claim 1, further comprising a wireless connection port to wirelessly connect the apparatus to at least one of a computer and a consumer electronics device.

7. The apparatus according to claim 1, further comprising a wireless connection port to wirelessly connect the apparatus to a computer and to a consumer electronics device.

8. The apparatus according to claim 1, wherein the apparatus is a handheld peripheral computer/consumer electronics convergence device.

9. The apparatus according to claim 1, wherein the apparatus is a universal remote configurable by a computer.

10. The apparatus according to claim 1, wherein the mouse features further include a scroll wheel, and wherein the scroll wheel may be used to perform at least one of the following functions on at least one of a computer, a consumer electronics device, and a convergence computer/consumer electronics device: adjust volume, navigate channels, navigate a scroll bar, perform a zoom function, fast forward, and rewind.

11. The apparatus according to claim 1, wherein the apparatus is to control a computer and a consumer electronics device.

12. The apparatus according to claim 1, wherein the mouse features further include a scroll wheel.

13. The apparatus according to claim 12, wherein the scroll wheel is able to perform at least one of the following control functions on another device: volume adjustment, channel navigation, scroll bar navigation, zoom, fast forward, and rewind.

14. The apparatus according to claim 12, wherein the scroll wheel is able to perform at least one of the following control functions on a consumer electronics device: volume adjustment, channel navigation, scroll bar navigation, zoom, fast forward, and rewind.

15. A system comprising:
a screen;
media processed from a source and displayed on the screen; and
a peripheral to interface with the processed media displayed on the screen, the peripheral including:
mouse features that include surface based navigation such that a movement of the apparatus relative to another object is translated into electronic signals to interact with the processed media; and
remote control unit features.

16. The system according to claim 15, wherein the mouse features further include a scroll wheel and at least one mouse click button.

17. The system according to claim 15, wherein the surface based navigation of the mouse features includes an optical mouse transception device on the bottom of the peripheral.

18. The system according to claim 15, wherein the remote control unit features are features including number buttons and at least one mode selection button.

19. The system according to claim 15, further comprising a wireless connection port to wirelessly connect the peripheral to interact with the processed media displayed on the screen.

20. The system according to claim 15, wherein the peripheral is a handheld peripheral computer/consumer electronics convergence device.

21. The system according to claim 15, wherein the peripheral is a universal remote configurable by a computer.

22. The system according to claim 15, wherein the mouse features further include a scroll wheel, and wherein the scroll wheel may be used to perform at least one of the following functions on the displayed media: adjust volume, navigate channels, navigate a scroll bar, zoom, fast forward, and rewind.

23. The system according to claim 15, wherein the peripheral device is to control the displayed media using the mouse features and the remote control unit features.

24. The system according to claim 15, wherein the screen is included within at least one of a computer, a consumer electronics device and a convergence computer/consumer electronics device.

25. The system according to claim 24, wherein the consumer electronics device is at least one of a VCR, a TV, a set top pointing device, a set top box, a set top device, a set top computer, a CD player, a CD recorder, a DVD player, a DVD recorder, an MP3 player, an MP3 recorder, a personal video player, and a personal video recorder.

26. The system according to claim 15, wherein the mouse features further include a scroll wheel.

27. The system according to claim 26, wherein the scroll wheel is able to perform at least one of the following control functions on the displayed media: volume adjustment, channel navigation, scroll bar navigation, zoom, fast forward, and rewind.

28. A method comprising:
performing media control and computer control using a single device that includes mouse functions and remote control functions, the mouse functions including surface based navigation such that a movement relative to another object is translated into electronic signals.

29. The method according to claim 28, further comprising enabling a switching between the media control and the computer control based on a context of the device.

30. The method according to claim 28, further comprising wirelessly connecting the device to a computer and to a consumer electronics device.

31. The method according to claim 28, wherein the device is a universal remote, and further comprising configuring the universal remote using a computer.

32. The method according to claim 28, wherein the mouse features further include a scroll wheel, and wherein the scroll wheel may be used to perform at least one of the following functions on at least one of a computer and a consumer electronics device: adjust volume, navigate channels, navigate a scroll bar, zoom, fast forward, and rewind.

33. The method according to claim 28, further comprising controlling a computer and a consumer electronics device using the mouse features and the remote control unit features.

34. The method according to claim 28, further comprising using the surface based navigation as a scrubbing tool to move rapidly through processed media.
